(19) United States
(12) Patent Application Publication
(10) Pub. No.: US 2002/0006595 A1
(43) Pub. Date: Jan. 17, 2002

(54) Orthodontic tools

(76) Inventor: John C. Voudouris, Toronto (CA)

Correspondence Address: MICHAEL BEST & FRIEDRICH, LLP, 100 E WISCONSIN AVENUE, MILWAUKEE, WI, 53202, US

(21) Appl. No.: 09/842,308

(22) Filed: Apr. 25, 2001

(30) Foreign Application Priority Data
Apr. 25, 2000 (CA) 2,306,504

(51) Int. Cl. A61C 3/00; A61C 3/14

(52) U.S. Cl. 433/4; 433/3; 433/159

(57) ABSTRACT

The present invention provides several tools that can be used in connection with orthodontic treatment using orthodontic brackets. One of the tools has a first member that engages a notch of a self-ligating orthodontic bracket. The tool also has a second member engaged with the first member and adapted to engage a free end of a locking member in order to disengage the locking member when the first and second members are squeezed toward each other. Another tool has a pair of notches that are adapted to engage an archwire on both sides of a tooth in order to seat an archwire in an archwire slot. In one embodiment, there is provided an instrument having a first end and a second end. The first end has a guiding member having two spaced-apart arms. Each of the arms defines a notch formed thereon capable of engaging an archwire whereby the guiding member can engage an archwire on both sides of a tooth to guide the archwire into an archwire slot of an orthodontic bracket. A third tool is a positioning tool that helps position and seat an orthodontic bracket. The positioning tool is an elongated instrument having a planar positioning tool formed on an end thereof. The positioning tool has spaced demarcation or scribe lines formed thereon for measuring the height or position of an orthodontic bracket. The positioning tool is adapted to position the orthodontic bracket on a tooth.

### FIELD OF THE INVENTION

The present invention relates to tools for use in the area of orthodontics.

### BACKGROUND

Certain self-ligating orthodontic brackets presently in use are opened by depressing a portion of the locking shutter that extends from the back of the bracket when in a closed position. These brackets are often difficult to open because the orthodontist is required to reach to the back of the bracket with an opening instrument. The back of the bracket can often be obstructed by food or other debris making it difficult to see the portion of the locking shutter that the orthodontist must depress to open the bracket. Also, it is difficult for those orthodontists whose vision may be slightly impaired to see the back portion of the bracket.

There is therefore a need for a tool for a self-ligating orthodontic bracket that enables orthodontists to open the bracket from a front portion of the bracket, which is easier to access. There is also need for a modified self-ligating orthodontic bracket that can be used in association with a tool that enables orthodontists to open the bracket from a front portion of the bracket.

Normally, a set of upper or lower teeth define a symmetrical and uniform archform. In many cases, however, one or more teeth can be either completely or partially displaced. When a patient requires orthodontic work, this displacement provides a challenge for the orthodontist. An orthodontic bracket must be placed on each tooth. An archwire must be seated in an archwire slot of each of the brackets. It is difficult to seat the archwire in the archwire slot of displaced teeth. It is helpful to use a tool for this purpose.

Previously, a very small fork-shaped tool has been used to seat the archwire. The tool is difficult to use because it can only engage one side of the archwire. Where a tooth is completely displaced, it is necessary to engage both sides of the archwire in order to seat the archwire. The small fork shaped tool is inconvenient for this purpose. There is therefore a need for an archwire-seating tool that is convenient to use and that can engage an archwire on both sides of the tooth.

Bracket placement is a very important orthodontic procedure. When fastening an orthodontic bracket to the tooth, the orthodontist must measure a predetermined distance between the bottom of the tooth and the bottom of the bracket depending on the type of tooth. This helps the orthodontist to place the bracket on the proper position on the tooth. Several instruments have been used in the past. A first instrument would be used to measure the height of the bracket from the cusp tip. A second instrument would be used to seat the bracket firmly on the tooth. A third instrument would be used to clean up the resin bonding material after seating the bracket. This system has the drawback of being unwieldy in view of the number of instruments that must be used. There is therefore a need for an instrument that can measure heights of brackets and can position the brackets on the tooth.

An orthodontic bracket is placed on each of a patient's upper and/or lower teeth. The brackets each receive an archwire that connects the brackets to apply a corrective force on the teeth. Most archwires that are presently used by orthodontists are wider buccolingually (from front to back) than they are occlusogingivally (top to bottom). With some types of self-ligating brackets, a locking shutter engages an exterior-facing portion of the archwire when the locking shutter is in a closed position. The force that the locking shutter applies to the archwire is translated to the tooth. When rectangular wires are used in self-ligating brackets on teeth that are tipped from profile view, the archwire occasionally does not seat properly in the upper corner of the archwire slot defined between the rear of the bracket and the locking shutter. There is therefore a need for an archwire that is proportioned to seat more effectively against a locking shutter in an archwire slot.

### SUMMARY OF THE INVENTION

The present invention provides several tools that can be used in connection with orthodontic treatment using orthodontic brackets.

One of the tools has a first member that engages a notch of a self-ligating orthodontic bracket. The tool also has a second member engaged with the first member and adapted to engage a free end of a locking member in order to disengage the locking member when the first and second members are squeezed toward each other.

Another tool has a pair of notches that are adapted to engage an archwire on both sides of a tooth in order to seat an archwire in an archwire slot. In one embodiment, there is provided an instrument having a first end and a second end. The first end has a guiding member having two spaced-apart arms. Each of the arms defines a notch formed thereon capable of engaging an archwire whereby the guiding member can engage an archwire on both sides of a tooth to guide the archwire into an archwire slot of an orthodontic bracket.

A third tool is a positioning tool that helps position and seat an orthodontic bracket. The positioning tool is an elongated instrument having a planar positioning tool formed on an end thereof. The positioning tool has spaced demarcation or scribe lines formed thereon for measuring the height or position of an orthodontic bracket. The positioning tool is adapted to position the orthodontic bracket on a tooth.

The present invention also provides an archwire that is designed to have an enhanced interface with a locking member of a self-ligating bracket. More specifically, the archwire has a beveled edge to seat against a locking member when positioned in an archwire slot.

### BRIEF DESCRIPTION OF THE DRAWINGS

FIG. 1 is a perspective view of an orthodontic tweezer tool embodying the present invention.

FIG. 2 is a perspective view of a self-ligating bracket.

FIG. 3 is a perspective view of the tweezer tool of FIG. 1 inserted insert the self-ligating bracket of FIG. 2.

FIG. 4 is a section view of the self-ligating bracket of FIG. 3 showing use of the tweezer tool.

FIG. 5 is a perspective view of a double-ended orthodontic multi-purpose tool.

FIG. 6 is an occlusal view of the multi-purpose tool used to seat an archwire in an orthodontic bracket.

FIG. 7 is an end view of an alternative way of using the multi-purpose tool to seat an archwire.

FIG. 8 illustrates use of a second end of the multi-purpose tool to open the locking member of the bracket.

FIG. 9 is a section view of FIG. 8.

FIG. 10 illustrates a placement instrument embodying an aspect of the present invention.

FIG. 11 illustrates use of the placement instrument to position an orthodontic bracket onto a tooth.

FIG. 12 illustrates an archwire having a beveled edge.

### DETAILED DESCRIPTION

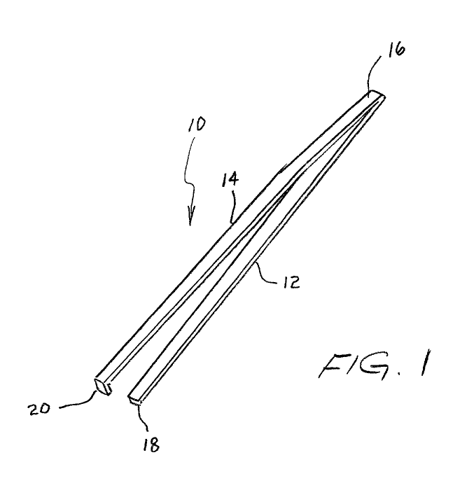

Tweezer Tool (FIGS. 1-4)

FIG. 1 illustrates a tweezer tool 10 embodying one aspect of the present invention. The tweezer tool 10 has a first member 12 and a second member 14. The first and second members are connected at junction 16. The first member 12 has an end 18 that is preferably rectangular in cross-section although other shapes are within the purview of the present invention. The second member 14 has an end 20 that preferably has an inverted L shape, although other shapes are within the purview of the present invention.

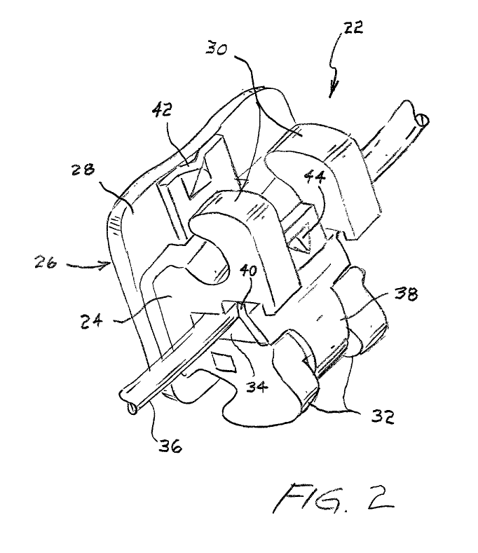

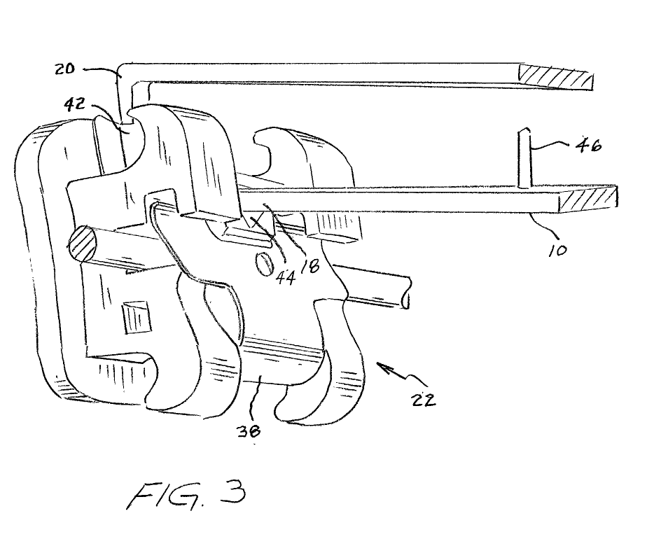

As shown in FIGS. 2-4, the tweezer tool 10 is used in association with a self-ligating orthodontic bracket 22. The bracket 22 generally includes a base 24 having a lingual portion 26 for attachment to a tooth by means of a mounting pad 28 or other suitable means. A pair of gingival tie wings 30 and a pair of occlusal tie wings 32 extend from the base in a buccal-labial direction. An archwire slot 34 extends generally horizontally across the base 24 and opens for receiving an archwire 36.

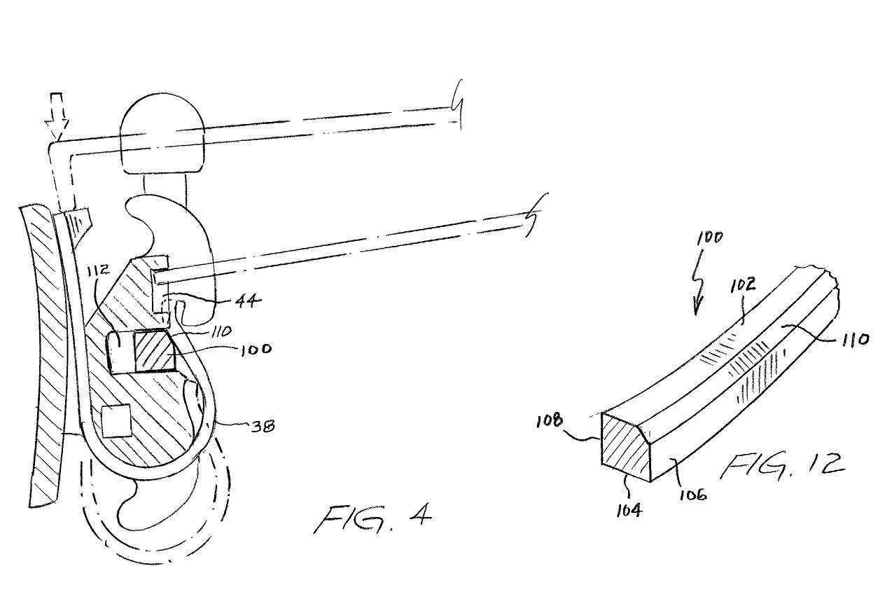

The bracket 22 further includes a sliding locking member 38 generally in the shape of a “U”. The locking member 38 curves at one end to form a generally hook-shaped catch 40 and at the opposite end a stopper 42 is attached for contacting the base 24, thereby preventing the locking member 38 from sliding off of the base 24 in the open position. The locking member 38 is movable from a closed position (shown in solid lines in FIGS. 3 and 4) to an open position (shown in broken lines in FIG. 4). The general operation of the bracket and locking member is disclosed in more detail in European Patent Publication No. 1090604, which is incorporated herein by reference in its entirety.

In operation, the first end 18 engages a notch 44 formed in a front face of the bracket 22. Preferably the notch is V-shaped. The second end 20 is engaged to the stopper 42 of the locking member 38. The locking member becomes disengaged from the bracket when the second end 20 applies a force against the stopper 42. The tweezer tool 10 is calibrated such that when the first end 18 is engaged to the notch 44, the second end 20 engages the stopper 42 of the locking member 38. Squeezing pressure on the stopper 42 causes the locking member 38 to move to the open position. A compression stop 46 prevents over stressing the tool 10.

The tweezer tool 10 can be used in association with both upper tooth and lower tooth orthodontic brackets.

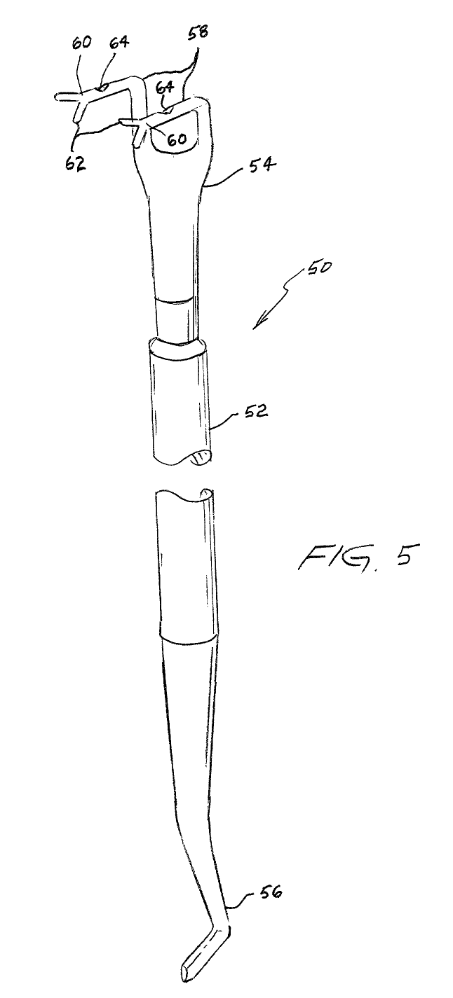

Double-ended Multi-Purpose Tool (FIGS. 5-9)

FIG. 5 illustrates a multi-purpose tool 50 embodying another aspect of the invention. The multi-purpose tool 50 has a main shaft 52, a first end 54, and a second end 56. The first end 54 has arms 58 that are substantially perpendicular to the shaft 52 and that preferably define a U shape. The arms 58 have fork-shaped ends 60 that each have prongs 62 defining a recess. Each of the arms further defines a notch 64 formed in an exterior surface of the ann near a midpoint of the arm.

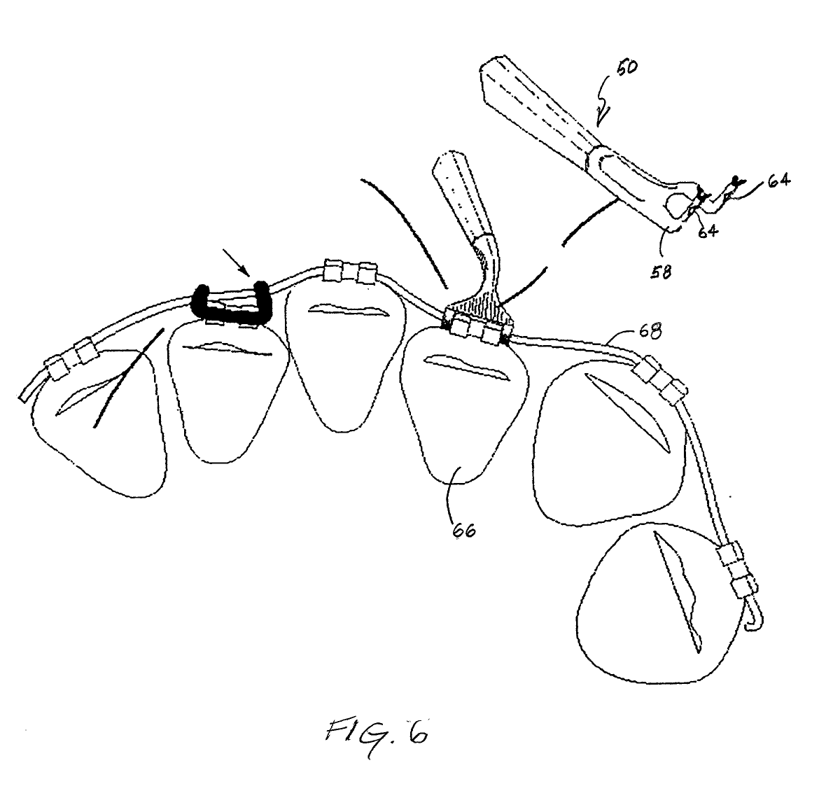

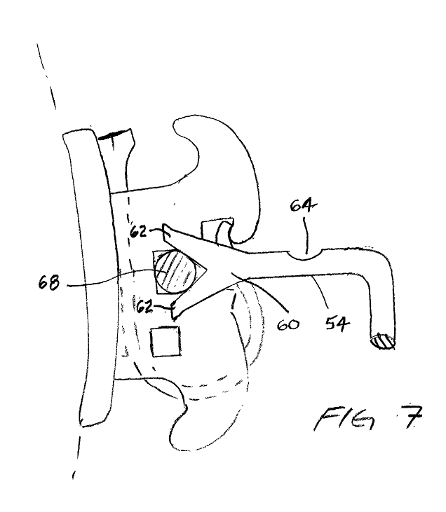

The operation of the first end 54 of the tool 50 is shown in FIGS. 6 and 7. A completely displaced tooth 66 is shown in FIG. 6. The tool 50 engages an archwire 68 on both sides of the tooth 66. The archwire 68 is received in notches 64 so that the tool can be used to direct the archwire 68 into an archwire slot of the orthodontic bracket. The substantially perpendicular angulation of the arms 58 allows the orthodontist to see the archwire slot clearly while directing the archwire 68 into the archwire slot.

Referring to FIG. 7, the fork shaped ends 60 and corresponding prongs 62 allow an orthodontist to seat only one side of an archwire 68 into an archwire slot. This is useful where a tooth is only partially displaced such that it is not necessary to direct the archwire 68 on both sides of the tooth into the archwire slot. It should be understood that the first end 54 of the tool 50 only needs one arm 58 to seat one side of the archwire 68.

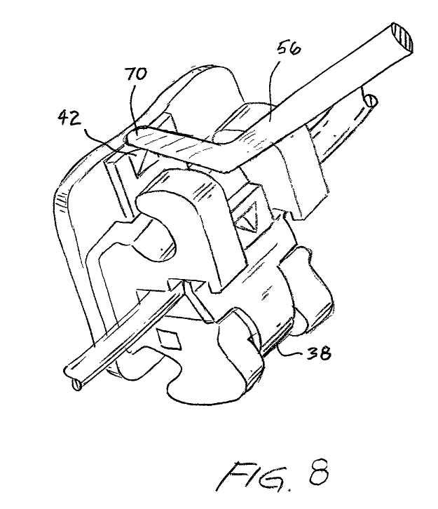

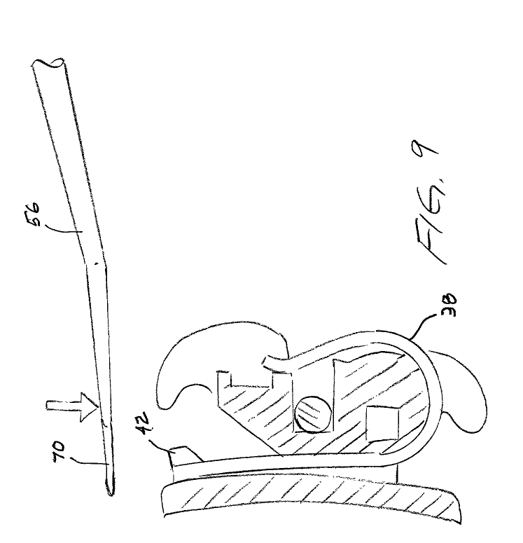

FIGS. 8 and 9 show the operation of the second end 56 of the tool 50. The second end 56 defines a generally L-shaped tool having a flattened head 70. The second end 56 is useful for opening a self-ligating orthodontic bracket by pressing vertically on a back end or stopper 42 of the locking member 38.

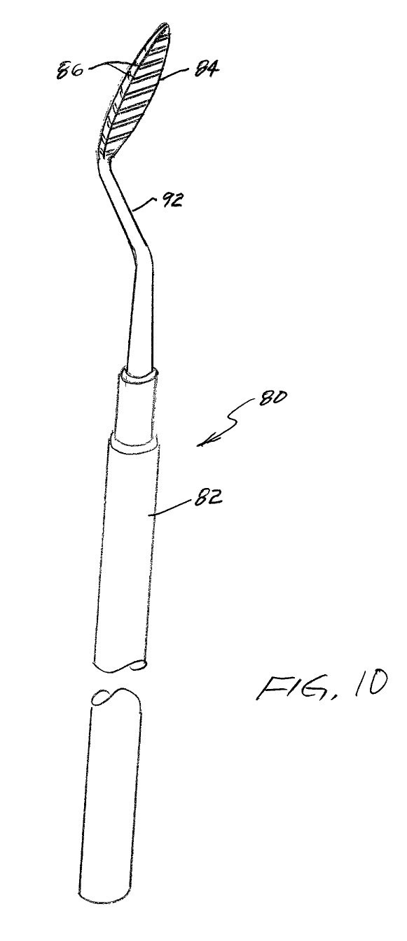

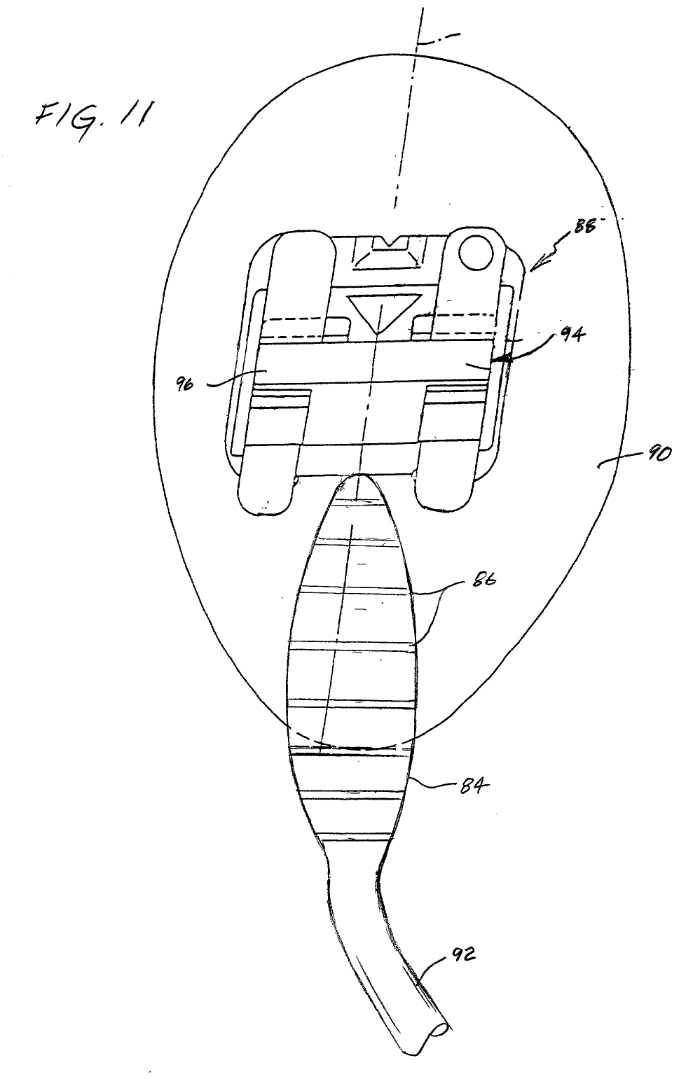

Placement Instrument (FIGS. 10-11)

Referring to FIGS. 10 and 11, the placement instrument 80 has a shaft 82 and planar positioning tool 84 formed at one end of the shaft. The planar positioning tool 84 has measured scribe lines 86 formed thereon for measuring the height of a bracket 88 on a tooth 90. Preferably the scribe lines 86 are 1 mm apart. Preferably the planar positioning tool 84 is elongated and spade shaped as shown in the figures. The instrument 80 has a neck 92 that is bent such that the planar positioning tool 84 is substantially perpendicular to the shaft 82.

In operation, the scribe lines 86 of the positioning tool 84 are used to measure the height of the bracket 88 from the edge of the tooth 90, as shown in FIG. 11. The positioning tool 84 is aligned along the longitudinal axis of the tooth 90. One can measure the height of the bracket 88 from the cusp tip to the bottom of the bracket pad using the scribe lines. The bend in the neck 68 makes the planar positioning tool 64 useful in accessing the posterior teeth for positioning the heights of the brackets on those teeth. The instrument 80 is also useful for seating the bracket 88 firmly against the tooth 90 by inserting the positioning tool 84 into the open archwire slot 94 when the locking member 96 is open. In addition, the tool 84 can be used to removed excess bonding material from around the edge of the bracket 88.

Archwire with Beveled Edge (FIGS. 12 and 4)

FIG. 12 illustrates an archwire 100 embodying an aspect of the present invention. The archwire 100 has an upper edge 102, a lower edge 104, a front edge 106, and a rear edge 108. The archwire 100 is preferably square shaped or rectangular shaped in cross-section. The archwire 100 further includes a beveled edge 110 at the junction between the upper edge 102 and the front edge 106. The archwire of the present invention is preferably made of nickel and titanium, stainless steel, TMA or elgiloy. Many other materials can also be used.

FIG. 4 shows the archwire 100 in an operational position. The archwire 100 is seated in an archwire slot 112 against the locking member 38 in a closed position. The locking member 38 engages the beveled edge 110 of the archwire 100.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. An orthodontic tool for facilitating opening of a self-ligating bracket having a notch, the tool comprising:
a first member adapted to engage the notch of the self-ligating bracket; and
a second member movable coupled with the first member and adapted to engage a free end of a locking member in order to disengage the locking member when the first and second members are squeezed toward each other.
